(19) United States
(12) Patent Application Publication
(10) Pub. No.: US 2006/0056061 A1
(43) Pub. Date: Mar. 16, 2006

(54) Optical image device

(75) Inventor: Tzu-Kan Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: E-PIN OPTICAL INDUSTRY CO., LTD, Taipei (TW)

(21) Appl. No.: 10/711,393

(22) Filed: Sep. 16, 2004

(51) Int. Cl. G02B 13/18

(52) U.S. Cl. 359/708

(57) ABSTRACT

An optical image device, having a lens module, an IR cut coating and an image sensor. The lens module has a molded glass aspheric lens and aspheric lens. The molded glass aspheric lens is disposed at one end near an object of which the image is to be captured, the IR cut coating is formed on the molded glass aspheric lens, and the image sensor is located behind the lens module to capture the image of the object. In addition to the lens module, the IR cut coating and the image sensor, the optical image device may further include a protective glass disposed on the image sensor.

### BACKGROUND OF THE INVENTION

1. Field of the Invention

The invention relates in general to an optical image device, and more particularly, to an optical image device that directly integrates an infrared (IR) cut filter into a molded glass aspheric lens.

2. Related Art of the Invention

Electronic products are continuously developed to be lighter, thinner, shorter, smaller and multi-functional. In addition to the digital still camera, the personal camera, the network camera, the cellular phone and the personal digital assistant all have had image devices integrated therein. To be portable and personalized, the image device requires good display quality, small volume and low cost. As the human eye is sensitive to the wavelength range from about 400 nm to about 700 nm, an IR cut filter is typically disposed in front of the charge-coupled device (CCD) or complementary metal-oxide semiconductor (CMOS) in the optical image device to capture an image similar to those captured by the human eye.

FIG. 1 shows the spectrum of an IR cut filter in a conventional optical image device. As shown in FIG. 1, the transmittance of the IR cut filter for different wavelength affects the color performance of the image. Typically, the transmittance of the IR cut filter is about less than 3% for the wavelength between 700 nm and 1000 nm, about 50% for the wavelength between 650 nm and 390 nm, and larger than 85% for the wavelength between 410 nm to 630 nm. Normally, the IR cut filter requires 20-40 layers of optical thin film coated on a glass substrate to obtain the proper transmittance requirement.

FIG. 2 shows a cross sectional view of a conventional optical image device. Referring to FIG. 2, a typical optical image device 100 includes a lens module 102, an image sensor 104 and an IR cut filter 106. The light from object sequentially travels through the lens module 102 and the IR cut filter 106 to form image on the image sensor 104 to achieve the image capture. The lens module 102 is normally composed of multiple lenses since a single lens can hardly resolve the problem of chromatic aberration. Therefore, the lens module 102 used in the high performance optical image device is normally a composite of lenses. The image sensor 104 is normally selected from either a charged-coupled device or CMOS. A cover glass 108 is typically implemented on the image sensor 104, and the IR cut filter 106 can be directly coated on the cover glass 108 of the image sensor 104 or on another glass substrate.

When the IR cut filter 106 is coated on the cover glass 108 of the image sensor 104, the specification of dust, scratch and dig etc. will become more severe because cover glass 108 is very close to senor 104. Any dust drops from cover glass to sensor can block several pixels' image. If the IR cut filter 106 is coated on a separate substrate, it will cause a negative effect on the volume, weight and cost of the optical image device 100. Because of the above problems, there is a huge demand to coat IR cut filter on lens element itself.

Since the technology to make polished glass spherical lens is mature and there are a variety of materials available for making polished glass spherical lens, the polished glass spherical lens has been broadly applied in optical industry. However, the polished glass spherical lens has a difficulty in correcting the spherical aberration and astigmatism aberration for large aperture or big field of view applications. To improve on the drawbacks, the aspheric plastic lens can be used to correct spherical aberration. However, the tolerable operation and storage temperature of plastic lens are far inferior to the lens made of glass material, so the application of plastic lens is limited. In addition, the plastic lens is easily scratched so that a planar glass is required for protection. This causes an increase in size and cost.

### SUMMARY OF THE INVENTION

The present invention provides an optical image device using a molded glass aspheric lens to solve the problems of polished glass spherical lens and aspheric plastic lens.

The present invention provides an optical image device on which an IR cut filter is formed on a molding glass aspheric lens to reduce volume, weight and cost thereof.

The optical image device includes a lens module, an IR cut coating and an image sensor. The lens module includes a molded glass aspheric lens and one aspheric lens. The molded glass aspheric lens is the first element of lens module and disposed at one side near the object. The IR cut coating is formed on the molded glass aspheric lens. The image sensor is disposed at the back of the lens module to capture the image of the object. In addition to the lens module, the IR cut coating and the image sensor, the optical image device may further include a cover glass disposed on the image sensor.

In the present invention, the glass-molding aspheric lens includes a meniscus lens. The meniscus lens has a convex surface and a concave surface. The convex surface is facing the object and the concave surface is facing the image sensor. One of the convex and concave surfaces is coated with the IR cut filter.

The second element in the lens module can be a molded glass aspheric lens or an aspheric plastic lens. The aspheric lens is a meniscus lens has a positive focal power. The stop of the lens module is located between the molded glass aspheric lens and second element, or between the molded glass aspheric lens and the object.

In the present invention, the first element is a molded glass aspheric lens and second element is an aspheric lens, for example. The aspheric lens includes a plastic lens or a molded glass lens with a positive focal power. In addition, the stop is located between the first element and the second element or between the first element and the object.

In one embodiment of the present invention, the optical image device includes a lens module, an IR cut coating and an image sensor. The lens module includes at least one molded glass aspheric lens as first element. The IR cut coating is formed on the first molded glass aspheric lens. The image sensor is disposed at back of the lens module to capture the image of an object. In addition to the lens module, the IR cut coating and the image sensor, the optical image device further comprises a cover glass on the image sensor.

### BRIEF DESCRIPTION OF THE DRAWINGS

These, as well as other features of the present invention, will become more apparent upon reference to the drawings.

FIG. 1 shows the spectrum of an IR cut filter in a conventional optical image device.

FIG. 2 shows the cross sectional view of a conventional optical image device.

FIG. 3 shows the cross sectional view of an optical image device in a first embodiment of the present invention.

FIG. 4 shows the cross sectional view of an optical image device in a second embodiment of the present invention.

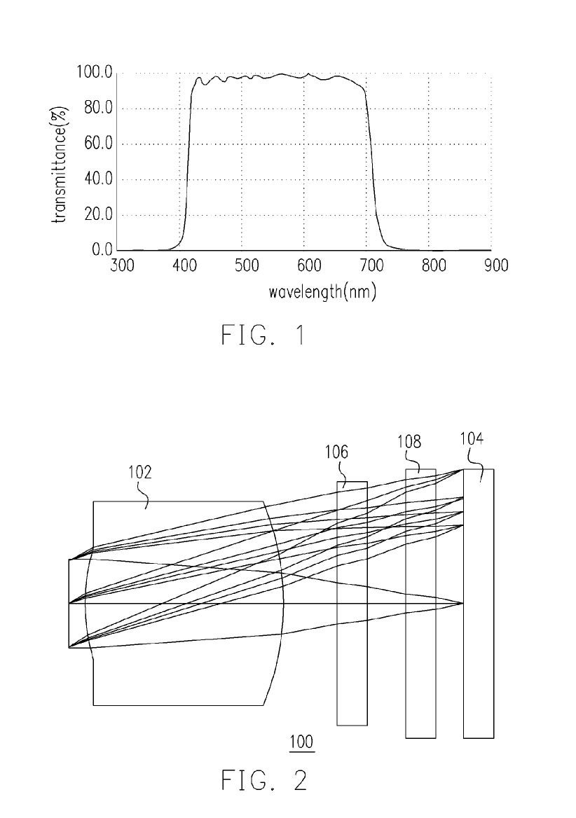

### DETAILED DESCRIPTION OF THE PREFERRED EMBODIMENT

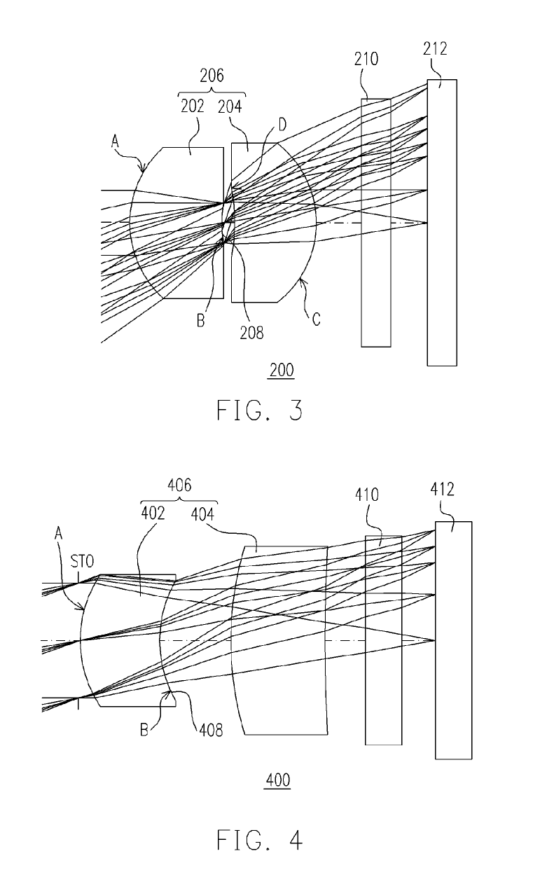

FIG. 3 shows the cross sectional view of an optical image device in a first embodiment of the present invention. As shown in FIG. 3, the optical image device 200 comprises a lens module 206, an IR cut coating 208 coated on the lens module 206, and an image sensor 212.

The lens module 206 usually comprises of multiple aspheric lenses, for example. In this embodiment, the lens module 206 includes at least one molded glass aspheric lens 202 and an aspheric lens 204. The aspheric glass-molding lens 202 includes, for example, a meniscus lens with a convex surface A facing to an object and a concave surface B facing to the image sensor 212. The aspheric lens 204 includes, for example, a meniscus lens. In the example of a meniscus lens, the aspheric lens 204 has a convex surface C facing to the image sensor 212 and a concave lens D facing to the object. The aspheric lens 204 has a positive power.

The aspheric lens 204 is made of a plastic lens or a molded glass lens, for example. The IR cut coating 208 includes, for example, a multi-layer coating coated on molded glass aspheric lens. As shown in FIG. 3, the IR cut coating 208 is preferably coated on the concave surface B of the molded glass aspheric lens 202. However, when the aspheric lens 204 is also a molded glass lens, the IR cut coating 208 can also be coated on the convex surface C or the concave surface D of the molded glass lens 204.

The stop of the lens module 206 is located between the aspheric glass-molding lens 202 and the aspheric lens 204. The image sensor 212 includes CCD or CMOS, for example. A cover glass 210 is optionally disposed on the image sensor 212.

According to the above, in the lens module 206 of the current embodiment, including a molded glass aspheric lens 202 and an aspheric lens 204, which can be a meniscus lens made of plastic or molded glass. The lens module 206 has to satisfy the following conditions:

(a) The molded glass aspheric lens 202 includes a meniscus lens with a convex surface A facing to the object.

(b) The aspheric lens 204 includes a meniscus lens with the convex surface C facing to the image sensor. The focal length of the aspheric lens 204 is positive.

The stop of the lens module 206 is located between the aspheric glass-molding lens 202 and the aspheric lens 204.

When the stop is located between the molded glass aspheric lens 202 and the aspheric lens 204, the system is more symmetric so coma aberration, distortion aberration and transverse chromatic aberration is lower. The lens parameters of the optical image device 200 is shown as Table 1

TABLE 1

| | Radius of | | |
|---|---|---|---|
| | Curvature | Thickness | Refractive Index |
| Object | ∞ | ∞ | |
| 1 | 1.91207 | 0.544152 | Nd = 1.806100, |
| | | | V = 40.9 |
| 2 | 2.05045 | 0.050712 | |
| Stop (STO) | ∞ | 0.169324 | |
| 4 | −5.082443 | 1.411840 | Nd = 1.806100, |
| | | | Vd = 40.9 |
| 5 | −1.90768 | 0.763565 | |
| 6 | ∞ | 0.500000 | BK7 |
| 7 | ∞ | 0.600000 | |
| Image | ∞ | 0.000000 | |
| (IMG) | | | |

Table 2 shows the coefficients of the aspheric lens.

TABLE 2

| | S1 | S2 | S4 | S5 |
|---|---|---|---|---|
| K | 0.102844 | −11.980803 | 19.357042 | −0.709569 |
| A | 0.324435E−2 | 0.262093 | −0.301406E−1 | 0.241326E−3 |
| B | 0.196235E−2 | 0.262129 | 0.531035E−1 | 0.246487E−1 |
| C | 0.519398E−3 | 0.108598E−1 | 0.295892 | 0.322935E−2 |
| D | 0.700962E−3 | 0.240398E+1 | −0.251002 | −0.118364E−2 |

Z=ch²/{1+[1−(1+K)c²h²]^{1/2}}+Ah⁴+Bh⁶+Ch⁸+Dh¹⁰ is the aspheric formula, where c is the radius of curvature and Z is the sag value.

FIG. 4 shows a second embodiment of an optical image device according to the present invention. In FIG. 5, the structure of the current embodiment is similar to that of the first embodiment. In this embodiment, similarly, the optical image device 400 includes a lens module 406, an IR cut coating 408 coated on the lens module 406, and an image sensor 412.

The lens module 406 comprises one molded glass aspheric lens 402 and an aspheric lens 404. The molded glass aspheric lens 402 includes a meniscus lens with a convex surface A facing to an object and a concave surface B facing to an image sensor 412, for example. The aspheric lens 404 includes, for example, a meniscus lens with a positive focal power.

The aspheric lens 404 includes a plastic lens or a molded glass lens, for example. The IR cut coating 408 includes a multi-layer coating coated on a glass material. As shown in FIG. 4, preferably, the IR cut coating 408 is formed on the concave surface B of the molded glass aspheric lens 402. However, when the aspheric lens 404 is also made of molded glass lens, the IR cut coating 408 can also be coated on the aspheric lens 404.

In this embodiment, the stop of the lens module 406 is located between the molded glass aspheric lens 402 and the object. The image sensor 412 includes, for example, a charge-coupled device or a CMOS sensor. A cover glass 410 can be optionally disposed on the image sensor 412.

According to the above descriptions, in the lens module 406 of the invention, the aspheric glass-molding lens 402 includes at least one molded glass aspheric lens, and the aspheric lens 404 is made of one aspheric plastic or molded glass lens. The lens module 406 has to satisfy the following conditions:

(a) The aspheric glass-molding lens 402 includes a meniscus lens with a convex surface A facing to the object.

(b) The aspheric lens 404 includes a meniscus lens with a positive focal length.

(c) The stop of the lens module 406 is located between the aspheric glass-molding lens 402 and the object.

In the lens module 406 of the current embodiment, since the stop is located between the aspheric glass-molding lens 402 and the object, the system distortion aberration is relatively large compared to the first embodiment. However, as the stop is located between the aspheric glass-molding lens 402 and the object, the distance between the exit pupil position and the image sensor 412 is longer, such that the incident angle of the edge chief ray incident onto the image sensor 412 is smaller. Consequently, the relative illumination at the edge is better than previous embodiment.

Accordingly, the present invention has at least the following advantages:

1. The lens module in the optical image device provided by the present invention includes a molded glass aspheric lens and one aspheric lens. The IR cut coating can be directly coated on the molded glass aspheric lens to save the cost of fabricating the IR cut coating in a separate glass. Further, the size of the optical image device is greatly reduced.

2. In the optical image device provided by the present invention, the molded glass aspheric lens and the aspheric lens are made of glass material, such that the position for coating the IR cut filter is more flexible.

3. In the optical image device provided by the present invention, the molded glass aspheric lens is more rugged and can withstand scratching. Therefore, the first lens made of molded glass is more advantageous.

4. In the optical image device of the present invention, the IR cut coating can be directly coated on the molded glass aspheric lens to save the fabrication of the cover glass on the image sensor. Therefore, the size and the cost of the optical image device can be further reduced.

5. In the optical image device of the present invention, the IR cut coating can be directly coated on the molded glass aspheric lens, such that the fabrication of an additional glass substrate is saved. The size and cost of the optical image device is further reduced.

Other embodiments of the invention will appear to those skilled in the art from consideration of the specification and practice of the invention disclosed herein. It is intended that the specification and examples be considered as exemplary only, with a true scope and spirit of the invention being indicated by the following claims.

What is claimed is:

1. An optical image device, suitable for capturing an image of an object, comprising:
a lens module, having a molded glass aspheric lens and one aspheric lens, the molded glass aspheric lens is located at one side near the object;
an infrared (IR) cut coating, formed on the molded glass aspheric lens; and
an image sensor, disposed at back of the lens module to capture the image of the object.

2. The optical image device according to claim 1,
wherein the molded glass aspheric lens includes a meniscus lens with a convex surface facing to the object.

3. The optical image device according to claim 2, wherein the IR cut coating is formed on the concave surface.

4. The optical image device according to claim 1, wherein the aspheric lens includes an aspheric meniscus lens.

5. The optical image device according to claim 1, wherein the aspheric lens includes a plastic lens.

6. The optical image device according to claim 1, wherein the aspheric lens includes a glass-molding lens.

7. The optical image device according to claim 1, wherein the aspheric lens has a positive focal length.

8. The optical image device according to claim 1, wherein the lens module has a stop located between the molded glass aspheric lens and the aspheric lens.

9. The optical image device according to claim 1, wherein the lens module has a stop located between the molded glass aspheric lens and the object.

10. The optical image device according to claim 1, further comprising a cover glass formed on the image sensor.
